(19) United States
(12) Patent Application Publication
(10) Pub. No.: US 2016/0350136 A1
(43) Pub. Date: Dec. 1, 2016

(54) ASSIST LAYER WITH AUTOMATED EXTRACTION

(71) Applicant: Google Inc., Mountain View, CA (US)

(72) Inventors: Thomas Ramon Karlo, San Francisco, CA (US); Aparna Chennapragada, Mountain View, CA (US); Michael Andrew Cleron, Menlo Park, CA (US); Ulas Kirazci, Mountain View, CA (US); Daniel Marc Gatan Shiplacoff, Los Altos, CA (US); Othar Hansson, Sunnyvale, CA (US); Jeff Boortz, San Francisco, CA (US); Dianne Hackborn, Mountain View, CA (US)

(21) Appl. No.: 14/804,861

(22) Filed: Jul. 21, 2015

Related U.S. Application Data
(60) Provisional application No. 62/167,257, filed on May 27, 2015.

(51) Int. Cl. G06F 9/44; G06K 9/82; G06F 3/0484

(52) U.S. Cl. CPC G06F 9/4446; G06F 3/04842; G06K 9/82

(57) ABSTRACT

In general, this disclosure is directed to techniques for outputting, by a computing device and for display at a display component that is operatively coupled to the computing device, a graphical user interface of an application. The computing device determines context data from content included in the graphical user interface. The computing device further determines, based at least in part on the context data, an indication of assistance that is contextually related to the content included in the graphical user interface. The computing device outputs the indication of the assistance.

This application claims the benefit of U.S. Provisional Application No. 62/167,257, filed May 27, 2015, the entire content of which is hereby incorporated by reference.

### BACKGROUND

Computing devices (e.g., smartphones, tablets, smart watches, activity trackers, heads-up display components, etc.) may output screen content for display. For example, a computing device may output a graphical user interface (GUI) that includes one or more graphical elements. The computing device may allow the user to interact with information on the device based on a variety of different inputs, such as single- and multi-touch gestures, speech input, pointing devices, and keyboards. To assist a user in finding information or performing various tasks, some computing devices may operate as automated personal assistants. For instance, the computing device may output recommendations in order to reduce the amount of user effort needed to locate information or perform tasks. However, some computing devices may generate recommendations that have limited relevance to the user. In such instances, the user may need to expend additional effort to locate information or perform tasks.

### BRIEF DESCRIPTION OF DRAWINGS

FIG. 1 is a conceptual diagram illustrating an example system including a computing device that provides an indication of assistance based on determined screen context of a display component, in accordance with one or more aspects of the present disclosure.

FIG. 2 is a block diagram illustrating an example computing device, in accordance with one or more aspects of the present disclosure.

FIG. 3 is a block diagram illustrating an example computing device that outputs screen content for display at a remote device, in accordance with one or more techniques of the present disclosure.

FIG. 4 is a conceptual diagram illustrating an example system including a server device that provides an indication of assistance based on determined screen context of a remote display component, in accordance with one or more aspects of the present disclosure.

FIG. 5 is a flow chart illustrating example operations of a computing device that implements techniques for determining an indication of assistance, in accordance with one or more aspects of the present disclosure.

### DETAILED DESCRIPTION

In general, this disclosure is directed to techniques for outputting indications of assistance to a user based on screen context of a graphical user interface that is displayed by a display component. For example, a computing device may extract or otherwise determine screen context data reflective of the current screen content of the display component and generate one or more indications of assistance for annunciation based on the screen context data. By capturing screen context data from screen content that is immediately visible to the user, techniques of the disclosure may improve the relevance of indications of assistance that are output. That is, because content displayed at the display component may be the primary focus of the user, using such content may improve the contextual relevance of indications of assistance.

In operation, the computing device may include a module executing with operating system privileges that traverses a view hierarchy of an application to determine which particular view in the application is associated with requisite content in the graphical user interface. Alternatively, the computing device may capture a screenshot of the graphical user interface and determine screen context data by performing an image analysis of the screenshot. In some examples, the computing device may evaluate one or more user interface elements of the graphical user interface to determine corresponding values for the elements, which the computing device can use as context data. By determining the context data based on screen content of the graphical user interface, a computing device may generate more relevant recommendations and/or determine more likely next actions for a user. Techniques of the disclosure may therefore reduce or eliminate the need for an application developer to explicitly code contextual data into the application itself in order to be used for generating indications of assistance. In this manner, techniques of the disclosure may provide a generalized approach for obtaining contextual data from any graphical user interface that is output for display.

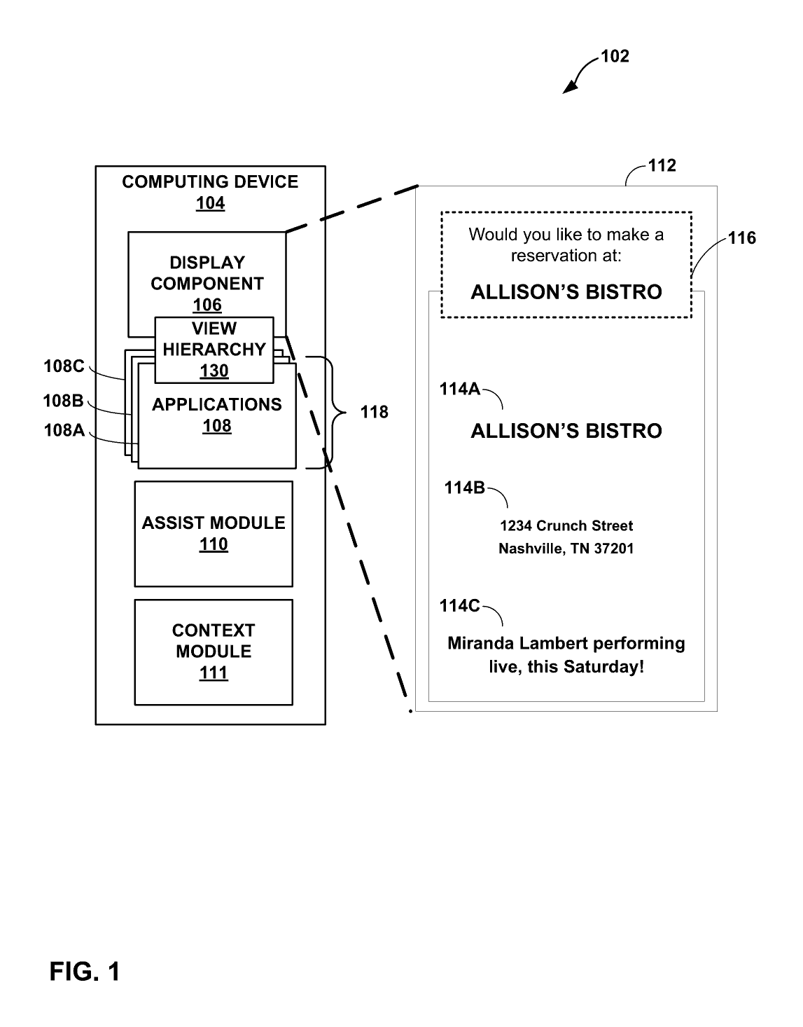

FIG. 1 is a conceptual diagram illustrating an example system including a computing device that provides an indication of assistance based on determined screen context of a display component, in accordance with one or more aspects of the present disclosure. As further described below, based at least in part on context data determined from content included in a graphical user interface output for display in a foreground or a user-selected location of a display component, a computing device may determine an indication of assistance that is contextually related to the content included in the graphical user interface.

As shown in FIG. 1, system 102 includes computing device 104. In the example of FIG. 1, computing device 104 is described as a mobile telephone. However, in some examples, computing device 104 may be a computerized watch (e.g., a smartwatch), computerized eyewear, computerized headwear, other types of wearable computing devices, a tablet computer, a personal digital assistant (PDA), a laptop computer, a gaming system, a media player, an e-book reader, a television platform, an automobile navigation system, a digital camera, or any other type of mobile and/or non-mobile computing device that is configured to control a display component. As will be described later, the display component may be integral to the computing device 104 or remote.

In this embodiment, computing device 104 includes display component 106, one or more applications 108, assist module 110, and context module 111. Modules 108, 110, and 111 may perform operations described herein using software, hardware, firmware, or a mixture of hardware, software, and/or firmware residing in and/or executing at computing device 104. Computing device 104 may execute modules 108, 110, and 111 with one or more processors. In some examples, computing device 104 may execute modules 108, 110, and 111 as one or more virtual machines executing on underlying hardware of computing device 104. Modules 108, 110, and 111 may execute as one or more services or components of operating systems or computing platforms of computing device 104. Modules 108, 110, and 111 may execute as one or more executable programs at application layers of computing platforms of computing device 104 with operating system privileges or with access to a runtime library of computing device 104. In some examples, display component 106, applications 108, and/or modules 110 and 111 may be arranged remotely to and be remotely accessible to computing device 104, for instance, via interaction by computing device 104 with one or more remote network devices.

Display component 106 of computing device 104 may include respective input and/or output components for computing device 104. In some examples, display component 106 may function as input component using a presence-sensitive input component, such as a resistive touchscreen, a surface acoustic wave touchscreen, a capacitive touchscreen, a projective capacitance touchscreen, a pressure sensitive screen, an acoustic pulse recognition touchscreen, or another display component technology. Display component 106 may also include a display component that can output content in a graphical user interface in accordance with one or more techniques of the current disclosure, such as a liquid device crystal display (LCD), a dot matrix display, a light emitting diode (LED) display, an organic light-emitting diode (OLED) display, e-ink, or similar monochrome or color displays capable of outputting visible information to a user of computing device 104.

In some examples, the presence-sensitive input component of display component 106 receives tactile input from a user of computing device 104. The presence-sensitive input component of display component 106 may receive indications of tactile input by detecting one or more gestures from a user (e.g., the user touching or pointing to one or more locations of display component 106 with a finger or a stylus pen). A display component of display component 106 may present output to a user. The display component of display component 106 may present the output as a graphical user interface (e.g., a user interface for viewing an alert based on notification data), which may be associated with functionality provided by computing device 104. For example, the display component of display component 106 may present various user interfaces related to the functionality of computing platforms, operating systems, applications, and/or services executing at or accessible by computing device 104 (e.g., notification services, electronic message applications, Internet browser applications, mobile or desktop operating systems, etc.). A user may interact with a user interface presented at display component 106 to cause computing device 104 to perform operations relating to functions.

As shown in FIG. 1, computing device 104 may include one or more applications 108A-108C which may be organized or otherwise structured in application list 118 by context module 111. Application list 118 may be a list, queue, collection, etc. of applications 108. In some examples, application list 118 may impose an order on the applications in which they can be iterated through for display. To determine which applications are presently active and/or stored in memory (and included in application list 118), context module 111 may execute in user space and access a component of an operating system on computing device 104, such as a process table or scheduler. In other examples, context module 111 may be included as a component within the operating system. In still other examples, context module 111 may query a separate manager module that manages application list 118 in order to determine a foreground application from application list 118. A running application 108 may create and modify a view hierarchy 130 that is used to control at least part of the graphical user interface shown by the display 106.

Context module 111 may analyze a view hierarchy for each running application 108, where the view hierarchy may be implemented as a list or other suitable data structure. Each view hierarchy may include a set of references to each element of a particular screen of a graphical user interface. For instance a view hierarchy of an application may include reference to a text view object that displays text, such that various properties (e.g., view object identifier, view object placement, etc.) of the text view object are accessible to context module 111. To illustrate, a user may be interacting with a first application 108A currently rendering a first graphical user interface. The user may then perform a first action and the first application 108A responds by rendering a different screen.

In accordance with one or more techniques of the current disclosure, display component 106 of computing device 104 may output graphical user interface 112 as directed by application 108A included in applications 108. Application 108A is included in the set of applications 108 in application list 118 of computing device 104. To illustrate, in the example of FIG. 1, display component 106 of computing device 104 may output graphical user interface 112 that may show user-requested information about restaurants, bars, or events. In the example of FIG. 1, graphical user interface 112 includes information about the restaurant Allison's Bistro, located at 1234 Crunch Street, in Nashville, Tenn. Also on the graphical user interface 112 is a promotion for a Miranda Lambert concert that is occurring that Saturday.

Context module 111 of computing device 104 may analyze the graphical user interface 112 for display component 106. In doing so, context module 111 may access view hierarchy 130. As stated above, context module 111 may operate with operating system privileges or be implemented in or have access to a runtime library of computing device 104 that allows context module 111 to access view hierarchy 130 and receive information regarding view objects that are part of the currently displayed graphical user interface 112. In some examples, view objects may be any item output for display by a computing device. Examples of view objects may include, but are not limited to, textual information, image information, frame information, linear information, pattern information, or button information, among other properties. In the example of FIG. 1, context module 111 determines from view hierarchy 130 that there are three key pieces of content: content 114A (from a view object named “restaurant_name_text”), content 114B (from a view object named “restaurant_address_text”), and content 114C (from a view object named “event_information_text”). Although each of content 114A-14C is shown as text, the underlying view object for content 114A-14C may be any type of view object as described above and may contain non-text content, text content, or both.

Responsive to determining that graphical user interface 112 of application 108A is output for display in the foreground of display component 106, context module 111 of computing device 104 may determine context data from content 114A-114C included in graphical user interface 112 and optionally use related view object properties to confirm or extract additional context data from content 114A-114C. In the example of FIG. 1, context module 111 may determine context data for each of the three view objects. For example, context module 111 may determine that content 114A includes a name of a restaurant. Context module 111 may determine that content 114B includes an address. Further, context module 111 may determine that content 114C includes a proper name and a date.

Assist module 110 of computing device 104 may determine, based at least in part on the context data determined above, an indication of assistance that is contextually related to content 114A-114C included in graphical user interface 112. In some examples, an indication of assistance may be a possible action to be conducted based at least in part on the context data and the content. In some examples, an indication of assistance may be additional information that is relevant to the context data of not only the content of the displayed screen but also of any underlying view object properties. Examples of indication of assistance may include, but are not limited to, reviews based on the text content 114A and more specifically restaurant reviews based on the text content 114A including the word “bistro” and/or the related view object name being “restaurant_name_text”, a reservation for the text content 114A based on the text content 114A including the word “bistro” and/or the related view object name being “restaurant_name_text”, information for text content 114C and more specifically ticket information based on the related view object name being “event_information_text”, a summons for a taxi or transportation to take a user to a location based on text content 114B based on the text content 114C being formatted as an address and/or the related view object name being “restaurant_address_text”, directions to a location based on the text content 114B, an event for a calendar based on text content 114C of the event view object, or search results for any textual or image view object, to name only a few examples.

To further illustrate, in FIG. 1, content 114A reflects text for a view object that indicates it is a restaurant name. Based on this type of view object as well as its content, assist module 110 may determine various forms of assistance that a user may like or find useful, including going to a website to make a reservation at the restaurant or to view the menu at the restaurant. Note that, because the view object indicates that “Allison's Bistro” is a restaurant name rather than a movie name, the assist module 110 can use the additional context data to confirm that the “bistro” portion of “Allison's Bistro” refers to a restaurant. If the name of the view object for content 114A was “movie_name_text”, the assist module 110 might provide a movie theater showtime indication in addition to, or in place of, a restaurant reservation indication. In another example, content 114B reflects text for a view object that indicates it is a restaurant address. Based on this type of content and context, assist module 110 may determine that the user may need directions to the address or to request a taxi to take him or her to that location. As a counterexample, if the name of the view object for content 114B was “movie_address_text”, the assist module 110 might provide an indication with movie theater showtimes at the address shown on the display component 106 in addition to, or in place of, a navigation or taxi-request indication. In yet another example, content 114C reflects text for a view object having event information. Based on this type of content, assist module 110 may determine that the user may be likely or wish to go to a ticket purchasing website to check on ticket availability for the event. Based on the type of content, assist module 110 may determine an indication of assistance for one or more of the key pieces of content 114A-114C.

Assist module 110 may utilize display component 106 of computing device 104 to output the indications of assistance. The indication of assistance may be in any suitable form for presentation, such as an overlay on the screen, an overlay near the content on the screen, a pop-up window within the graphical user interface, or an audio indication, to name only a few examples. For example, as described above, assist module 110 may generate or annunciate, an indication of assistance 116 based on content 114A that includes a user interface element overlaid at the top edge of graphical user interface 112 that includes a link to a website that allows the user to make a reservation based on the restaurant name textual content. Interacting with indication of assistance 116 may launch a reservation application, launch an internet browsing application for the restaurant's website, or cause assist module 110 to send a reservation request message directly to the restaurant, such as to the restaurant's remote server. In another example, assist module 110 may generate or annunciate an indication of assistance for content 114B including a user interface element that surrounds or highlights content 114B, and that when selected, launches a taxi application to summon a vehicle to take the user to the address in content 114B. In yet another example, assist module 110 may generate or annunciate an indication of assistance for content 114C including a user interface element that surrounds or highlights content 114C, and that when selected, launches a calendar application to put the event into the user's electronic calendar.

A user may request assist module 110 output in a variety of ways. As examples, the user may press a key, perform a touch gesture such as a long-press, or provide a voice command to request assist module indications. The user may also specify which application, and optionally which piece of content, the content module 111 should inspect for context data by, for example, pressing a key to cycle through running applications, continuing the initial touch gesture by dragging and lifting off from a selected window or piece of content, performing a second touch gesture by tapping within a selected window or on a piece of content, or providing a voice command indicating the requested application or piece of content including using a pronoun such as “that” or “it” to indicate an application or piece of content on graphical user interface 112. Assist module 110 may request other modules of computing device 104 perform a search for information that may assist a user in completing the inferred action or task. Assist module 110 may provide the information to the other modules for completing the task or delegate performing the action to one or more other computing devices for presentation to a user (e.g., as user interface of a networked computing device).

A user “need” as referred to herein, may be defined as a semantically grouped pattern of user actions in a given context, based on observations by a system of user actions (e.g., in action logs such as search histories, purchase histories, application usage histories, and other contextual histories). Note that this is just an example definition for simplifying discussion of the model used by assist module 110. By this example definition therefore, the tasks or actions may not necessarily be needs, rather observed actions taken or tasks performed may be a proxy by which assist module 110 can use to infer the more general needs of users of computing devices 104.

In summary, assist module 110 may perform one or more machine learning techniques to learn the needs of users of computing device 104 for different contexts. In other words, because assist module 110 may be unable to directly learn the needs of users of computing device 104 through the executing applications, assist module 110 models user needs. Assist module 110 may receive contextual information from context module 111 and provide that information as inputs to the model for training the model to learn the needs of users for given contexts. After training, the model may receive a particular context as an input and, in response, output an indication (e.g., data) indicative of one or more tasks, actions, or other observable acts previously performed by other users for the particular context. Assist module 110 may input the current context of computing device 104 into a model that assist module 110 uses to infer one or more actions typically performed by other users of computing device 104 given similar contexts. Simply put, assist module 110 may determine whether a degree of likelihood (e.g., a probability, a count, etc.) of the task being performed for the particular context sufficiently outweighs a degree of likelihood of the task being performed for a broader context. In this way, assist module 110 may only output needs information if the task that the user may have to perform is particularly out-of-the-ordinary or otherwise unique to a particular situation.

While the techniques of FIG. 1 have been described with respect to one or more operations on computing device 104, one or more operations of assist module 110 may be performed on a remote server. Context module 111 may send the contextual data to the remote server that determines possible indications of assistance, which are then sent to assist module 110, which is responsible for formatting the results and outputting the results to the screen in a particular form (such as an overlay).

By determining the context based on content of the graphical user interface displayed on the display component, a computing device may make recommendations about likely next actions for a user without relying on application developers to explicitly provide contextual information from the application. In this manner, techniques of the disclosure may provide mobile devices with the capability to determine likely next actions and provide indications of assistance for any application that the computing device may run without requiring application developers to include any additional code, simplifying the code of applications running on the computing device. By extracting textual information and/or image information from the screen being displayed by the application, techniques of this disclosure provide the content to an assist module that uses the context to provide indications of assistance regarding potential next actions based on what the graphical user interface 112 was showing rather than what the application developer explicitly provided via hard coding of contextual information. In providing functionality to the computing device to determine content and provide context, application coding is simplified and assistance can be provided universally across primary developer applications and third party applications in a reliable way. Further, techniques of this disclosure may allow assistance to be more generalizable to screen content that is output for display.

Throughout the disclosure, examples are described where a computing device and/or a computing system may analyze information (e.g., locations, speeds, etc.) associated with a computing device only if the computing device receives permission from the user to analyze the information. For example, in situations discussed below in which the computing device may collect or may make use of information associated with the user, the user may be provided with an opportunity to provide input to control whether programs or features of the computing device can collect and make use of user information (e.g., information about a user's current location, current speed, etc.), or to dictate whether and/or how to the computing device may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device.

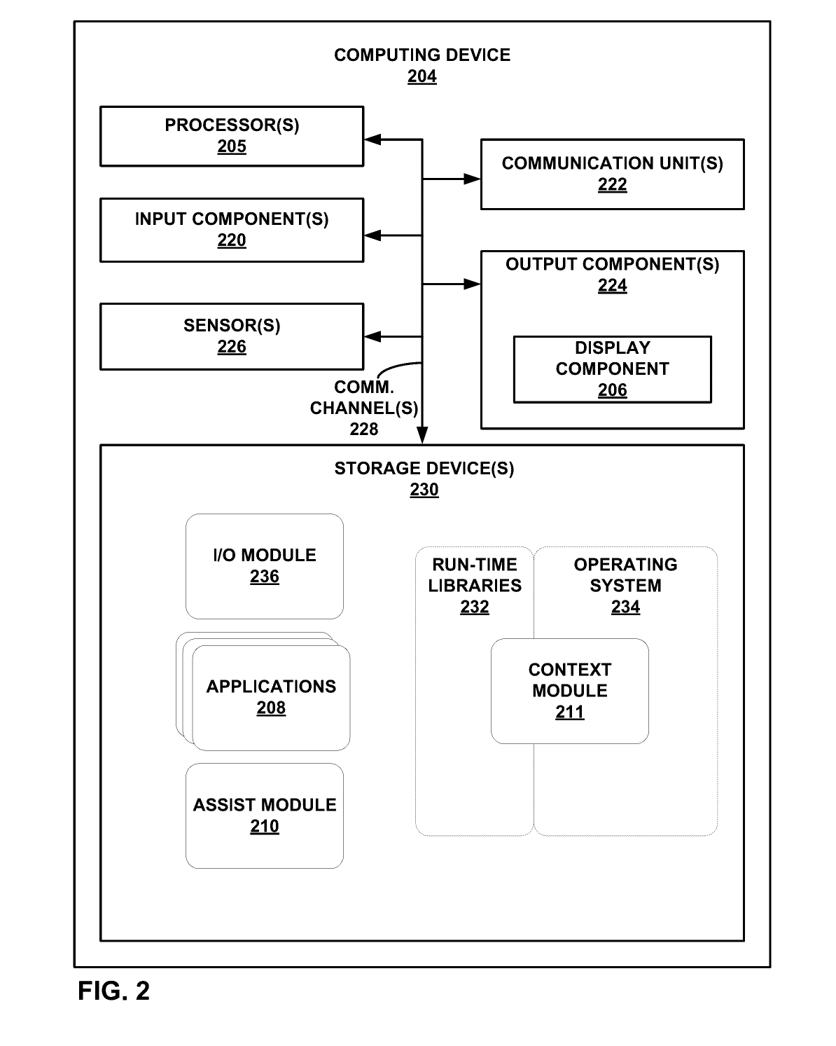

FIG. 2 is a block diagram illustrating an example computing device, in accordance with one or more aspects of the present disclosure. FIG. 2 illustrates only one particular example of computing device 204, and many other examples of computing device 204 may be used in other instances.

As shown in the specific example of FIG. 2, computing device 204 includes one or more processors 205, one or more input components 220, one or more communication units 222, one or more output components 224, one or more storage devices 230, one or more sensors 226, and display component 206. Computing device 204, in the example of FIG. 2 includes application list 208, assist module 210, context module 211, run-time libraries 232, operating system 234, and I/O module 236. Each of components 205, 206, 220, 222, 224, and 226 may be interconnected (physically, communicatively, and/or operatively) for inter-component communications. In some examples, communication channels 228 may include a system bus, network connection, inter-process communication data structure, or any other channel for communicating data. As one example in FIG. 2, components 205, 206, 220, 222, 224, and 226 may be coupled by one or more communication channels 228. Application list 208, assist module 210, context module 211, run-time libraries 232, operating system 234, and I/O module 236 may also communicate information with one another as well as with other components in computing device 204.

Processors 205, in one example, are configured to implement functionality and/or process instructions for execution within computing device 204. For example, processors 205 may be capable of processing instructions stored in storage device 230. Examples of processors 205 may include, any one or more of a microprocessor, a controller, a digital signal processor (DSP), an application specific integrated circuit (ASIC), a field-programmable gate array (FPGA), or equivalent discrete or integrated logic circuitry.

One or more storage devices 230 may be configured to store information within computing device 204 during operation. Storage device 230, in some examples, is described as a computer-readable storage medium. In some examples, storage device 230 is a temporary memory, meaning that a primary purpose of storage device 230 is not long-term storage. Storage device 230, in some examples, is described as a volatile memory, meaning that storage device 230 does not maintain stored contents when the computing device is turned off. Examples of volatile memories include random access memories (RAM), dynamic random access memories (DRAM), static random access memories (SRAM), and other forms of volatile memories known in the art. In some examples, storage device 230 is used to store program instructions for execution by processors 205. Storage device 230, in one example, is used by software or applications running on computing device 204 (e.g., application list 208) to temporarily store information during program execution.

Storage devices 230, in some examples, also include one or more computer-readable storage media. Storage devices 230 may be configured to store larger amounts of information than volatile memory. Storage devices 230 may further be configured for long-term storage of information. In some examples, storage devices 230 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 204, in some examples, also includes one or more communication units 222. Computing device 204, in one example, utilizes communication unit 222 to communicate with external devices via one or more networks, such as one or more wired or wireless networks. Communication unit 222 may be a network interface card, such as an Ethernet card, an optical transceiver, a radio frequency transceiver, or any other type of device that can send and receive information. Examples of such network interfaces may include Bluetooth, infrared signaling, 3G, LTE, and Wi-Fi radios as well as Universal Serial Bus (USB) and Ethernet. In some examples, computing device 204 utilizes communication unit 222 to wirelessly communicate with another computing device that is operably coupled to computing device 204.

Computing device 204, in one example, also includes one or more input components 220. Input component 220, in some examples, is configured to receive input from a user through tactile, audio, or video feedback. Examples of input component 220 include a display component, a mouse, a keyboard, a camera, a microphone or any other type of device for detecting input from a user. In some examples, a display component includes a touch-sensitive screen.

One or more output components 224 may also be included in computing device 204. Output component 224, in some examples, is configured to provide output to a user using tactile, audio, or video stimuli. Output component 224, in one example, includes an electronic display, a loudspeaker, or any other type of device for converting a signal into an appropriate form understandable to humans or machines. The electronic display may be an LCD or OLED part of a touch screen, may be a non-touchscreen direct view display component such as a CRT, LED, LCD, or OLED. The display component may also be a projector instead of a direct view display.

In some examples, display component 206 may include functionality of input component 220 and/or output component 224 and/or display component 218. In the example of FIG. 2, Display component 206 may be a display component. In some examples, a presence sensitive display may detect an object at and/or near the screen of the display component. As one example range, a display component may detect an object, such as a finger or stylus that is within 2 inches (˜5.08 centimeters) or less of the physical screen of the display component. The display component may determine a location (e.g., an (x,y) coordinate) of the display component at which the object was detected. In another example range, a display component may detect an object 6 inches (˜15.24 centimeters) or less from the physical screen of the display component and other exemplary ranges are also possible. The display component may determine the location of the display selected by a user's finger using capacitive, inductive, and/or optical recognition techniques. In some examples, presence sensitive display provides output to a user using tactile, audio, or video stimuli as described with respect to output component 224.

Computing device 204 may include operating system 234. Operating system 234, in some examples, controls the operation of components of computing device 204. For example, operating system 234, in one example, facilitates the communication of applications 208, assist module 210, context module 211, run-time libraries 232, and I/O module 236 with processors 205, communication unit 222, storage device 230, input component 220, output component 224, and display component 206. One or more components of storage devices 230 including applications 208, assist module 210, context module 211, run-time libraries 232, operating system 234, and I/O module 236 may each include program instructions and/or data that are executable by computing device 204. As one example, display component 206 may include instructions that cause computing device 204 to perform one or more of the operations and actions described in the present disclosure. In some examples, one or more of the components illustrated in storage device 230 may be implemented in hardware and/or a combination of software and hardware.

In some examples, computing device 204 may include one or more sensors 226. One or more of sensors 226 may measure one more measurands. Examples of one or more of sensors 226 may include one or more position sensors (e.g., a global positioning system (GPS) sensor, an indoor positioning sensor, or the like), one or more motion/orientation sensors (e.g., an accelerometer, a gyroscope, or the like), a light sensor, a temperature sensor, a pressure (or grip) sensor, a physical switch, a proximity sensor, and one or more bio-sensors that can measure properties of the skin/blood, such as alcohol, blood sugar etc.

I/O module 236 may receive and interpret inputs detected at display component 206 (e.g., as a user provides one or more gestures at one or more locations of display component 206 at which a user interface is displayed) and input detected at other input components of computing device 204 (e.g., microphones, cameras, sensors, physical buttons, etc.). I/O module 236 may relay information about the input detected at computing device 204 to one or more associated platforms, applications, and/or services executing at computing device 204, to cause computing device 204 to perform functions. For example, based on received input, I/O module 236 may initiate the techniques described herein. In one example, a user may perform an action that initiates the techniques on all of the content in the graphical user interface. In another example, the user may select a particular piece of content displayed in the graphical user interface for which the techniques will be performed.

I/O module 236 also may receive information and instructions from one or more associated platforms, applications, and/or services executing at computing device 204 (e.g., assist module 210, etc.) for generating a graphical user interface or for providing a somatosensory type user interface. In addition, I/O module 236 may act as a respective intermediary between the one or more associated platforms, operating systems, applications, and/or services executing at computing device 204 and various output components of computing device 204 (e.g., display component 206, one or more sensors 226, storage devices 230, a speaker, an LED indicator, other output components, etc.) to produce output (e.g., a graphic, a flash of light, a sound, a somatosensory response, a haptic response, etc.) with computing device 204.

In accordance with one or more techniques of the current disclosure, display component 206 of computing device 204 may output for display a graphical user interface (such as graphical user interface 112 of FIG. 1) of an application included in applications 208. The application is included in the set of applications in application list 218 of computing device 204. To illustrate, in the example of FIG. 2, display component 206 of computing device 204 may output a graphical user interface that may show an email from a contact discussing possible events for the weekend. For example, the graphical user interface may include the contact's name, a time, and the name of an establishment.

Context module 211 of computing device 204 may determine that graphical user interface of the application displaying the email is output for display in display component 206. In doing so, context module 211 may access application list 208 managed by context module 211. Context module 211 may determine which application is associated with graphical user interface 212 currently output for display in the foreground of display component 206. For instance, context module 211 may determine that application 208A is associated with or has otherwise generated graphical user interface 212 for application 208A. In some examples, graphical user interface 212 currently output for display in display component 206 may be associated with the most recently viewed or accessed application. As stated above, context module 211 may operate with operating system privileges or be implemented in or have access to runtime libraries 232 of computing device 204 that allow context module 211 to access the view hierarchy 230. Context module 211 may access the content of the currently displayed view. In some examples, view objects may be any item output by a computing device, such as in a graphical user interface. Examples of view objects may include, but are not limited to, textual information, image information, frame information, linear information, pattern information, or button information, among other properties. Context module 211 may identify a view object of the view hierarchy that is in the graphical user interface. Context module 211 may further extract at least one property of the view object and determine, based at least in part on the at least one property, the context data. In the example of FIG. 2, context module 211 determines from the graphical user interface that there are three view objects: the contact name, the time, and the establishment.

In some examples, in determining that that graphical user interface of the application displaying the email is output for display in a foreground of display component 218, context module 211 may access application list 208 of applications operating at computing device 204 to select the application associated with the graphical user interface in the foreground of display component 218. For example, with respect to the example of FIG. 2, context module 211 may access application list 208 and select the email application, as the email application is the application currently associated with the graphical user interface in the foreground of display component 218, as it is the application currently being displayed on display component 218. Context module 211 may further traverse the application list within application list 208, as the application list lists a set of applications running at computing device 204 in a temporal order of access by computing device 204, with the most recently accessed application on one extreme of the hierarchy and the application accessed longest ago on the other extreme.

Responsive to determining that the graphical user interface of the email application is output for display in the foreground of display component 206, context module 211 of computing device 204 may determine context data from the content included in graphical user interface. In the example of FIG. 2, context module 211 may determine context data on each of the three key pieces of data. For example, context module 111 may determine that the content includes a contact name, a time, and an establishment's name. In some examples, context data may be a determined general description of the content. Examples of context data may include, but are not limited to, a determination that the content is a restaurant name, a level of a video game, an address of a nearby place, a singer's name, or a calendar event, among other things.

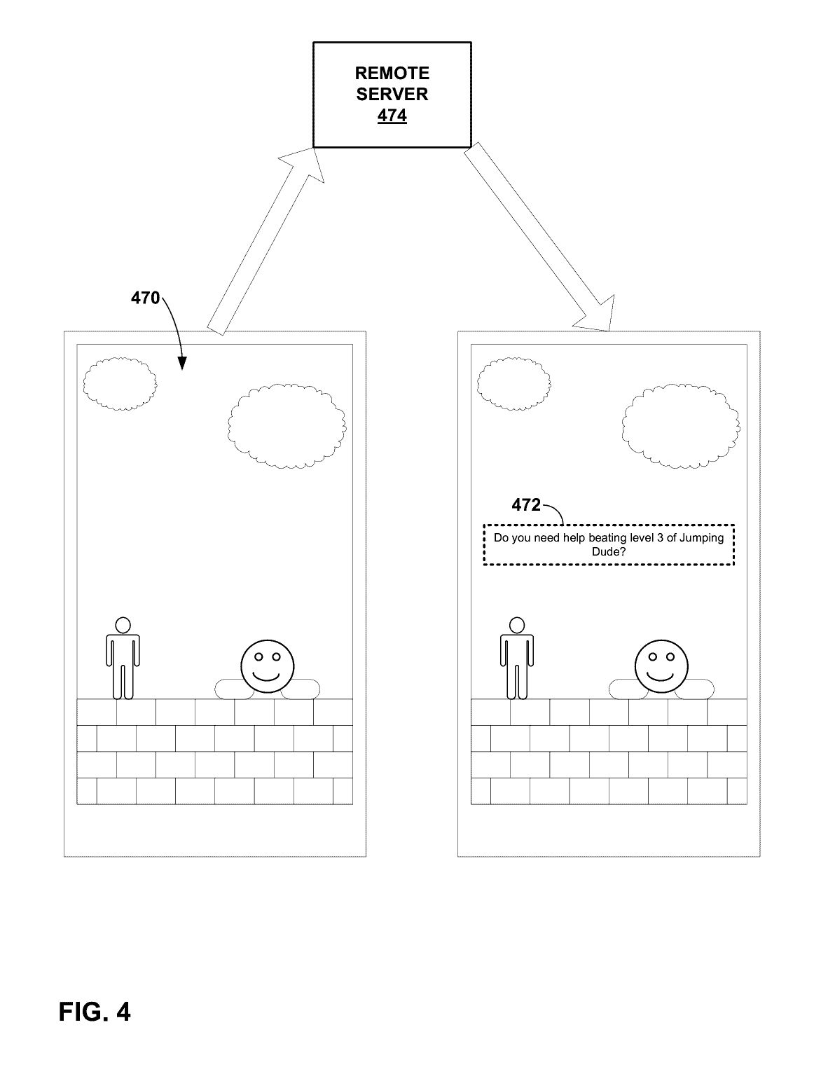

In some examples, in determining the context data, context module 211 may capture a screenshot of the graphical user interface of the application displayed in the foreground of display component 218. Context module 211 may perform an image analysis on the screenshot. Based at least in part on the image analysis, context module 211 may determine the context data. For example, context module 211 may perform an optical character recognition process on the screenshot to determine one or more characters in the screenshot, determining the context data based at least in part on the one or more characters. In the example of FIG. 2, since the application is an email application, context module 211 may perform the optical character recognition process on a screenshot of the email to determine the contents of the email such that context data may be derived. In other examples, the image analysis may be a web search using the image to determine a graphical image in the screenshot, as shown with the example of FIG. 4.

In other examples, in determining the context data, context module 211 may analyze the view hierarchy 230 of application 208. For a view object included in the view hierarchy, context module 211 may identify the view object. Context module 211 may further determine information associated with the identified view object and determine the context data based at least in part on the determined information. For instance, a view hierarchy of the graphical user interface, for a particular view or graphical user interface of an application, may be the structure of user interface elements that are included in the particular view or graphical user interface. Based on this structure of user interface elements, context module 211 may determine contents, such as text or images. For example, in the example of FIG. 2, context module 211 may traverse the view hierarchy of the graphical user interface showing the email, showing user interface elements such as the background of the application, the sender of the email, the subject of the email, and the body of the email. Based on these user interface elements, the content of each may be determined. For instance, context module 211 may determine the contact name based on the sender of the email, and context module 211 may determine the time and establishment based on the body of the email. Based on this determined content, context module 211 may determine the context data.

Assist module 210 of computing device 204 may determine, based at least in part on the context data determined above, an indication of assistance that is contextually related to the key content included in the graphical user interface. An indication of assistance may be a possible action to be conducted based at least in part on the context data and the content. Examples of indication of assistance may include, but are not limited to, looking at reviews of an establishment, obtaining a reservation for an establishment, obtaining tickets to an event, summoning a taxi to take a user to an address, obtaining directions to an address, searching for music by an artist, adding an event to a calendar, obtaining assistance for a video game, or searching for information on a person, place, or object, among other things. For example, the content may include the contact name of a restaurant. Based on this type of content, assist module 210 may determine various forms of assistance that a user may like or find useful, including displaying a pop-up image of the given contact's contact card or recently exchanged text messages between a user and the contact. In another example, the content may include the requested time for the meetup. Based on this type of content, assist module 210 may determine that the user is likely to view their current calendar for the requested time, add an event to your calendar at that time, or check a television schedule to see what programming the user may miss by attending the event with the contact. In yet another example, the content may include the establishment name. Based on this type of content, assist module 210 may determine that the user may be likely or wish to see reviews for this establishment, see a menu for this establishment if it is a restaurant, or see a location of the establishment.

Based on the type of content, and in some examples including secondary context data, assist module 210 may determine an indication of assistance for one or more of the key pieces of content. For example, the context data described above, including any context data derived from the content in the foreground of display component 218, may be considered primary context data. In determining the indication of assistance, assist module 210 may further make the determination based on both the primary context data and a set of secondary context data, or any context data that may be gathered about the content from outside of the application. For example, secondary context data may include a current location, a current time, a user identity, cloud computing data, calendar information, contact information, a previous application, and a temporal relation between a current time and a time that the previous application was run. For example, a user may have an event currently scheduled for the proposed time in the email. Assist module 210 may determine, based on the primary context data of the time in the email and the secondary context data of the event currently scheduled in the user's calendar, an indication of assistance that includes responding to the email with an alternate time for the meetup that coincides with perceived free time in the user's calendar. In another example, before accessing the email application, the user may have been using a web browser application to view a different establishment. Assist module 210 may determine this based on the application list showing that the web browser application was a previous application accessed by the user. There may also be a small temporal relation (i.e., almost instantaneous) between a current time and a time that the web browser application was run, i.e., the user transitioned between the web browser application and the email application. This may indicate that the user was researching establishments to meet the contact. As such, assist module 210 may determine, based on the primary context data of the establishment in the email and the set of secondary context data that includes the establishment in the web browser application and the temporal relation between accessing the two applications, an indication of assistance that includes responding to the contact proposing an alternate establishment as the meeting location.

Assist module 210 may, utilizing display component 206 of computing device 204, output the indications of assistance. The indication of assistance may be in any suitable form for presentation, such as an overlay on the screen, an overlay near the content on the screen, a pop-up window within the graphical user interface, or an audio indication, among other things.

For example, as described above, assist module 210 may generate, for display, an indication of assistance for the content that includes a user interface element overlaid at the top edge of the graphical user interface that includes a link to add the event at the given establishment to the user's calendar at the given time. Interacting with the indication of assistance may launch other applications as well, including an address book application, a restaurant review application, a television programming or online media streaming application, or any other application that may assist the user in a next action based on the displayed content.

While the techniques of FIG. 2 have been described with respect to one or more operations on computing device 204, one or more operations of assist module 210 may be performed on a remote server. Context module 211 may send the contextual data to the remote server that determines possible indications of assistance. The remote server may send the contextual data to assist module 210, which is responsible for formatting the results and outputting the results to the screen in a particular form (such as an overlay).

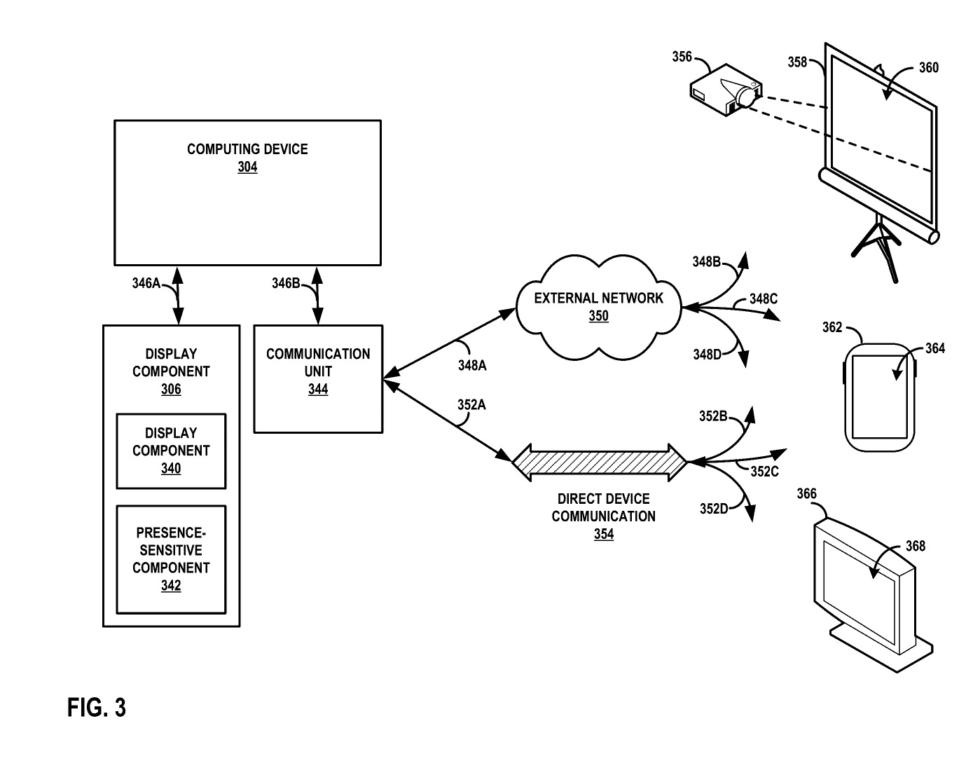

FIG. 3 is a block diagram illustrating an example computing device that outputs screen content for display at a remote device, in accordance with one or more techniques of the present disclosure. Screen content, generally, may include any visual information that may be output for display, such as text, images, a group of moving images, etc. The example shown in FIG. 3 includes a computing device 304, display component 306, communication unit 322, projector 356, projector screen 358, mobile device 362, and visual display component 366. Although shown for purposes of example in FIGS. 1 and 2 as a stand-alone computing device 104 and 204, respectively, a computing device such as computing device 304 may, generally, be any component or system that includes a processor or other suitable computing environment for executing software instructions and, for example, need not include a display component.

As shown in the example of FIG. 3, computing device 304 may be a processor that includes functionality as described with respect to processor 205 in FIG. 2. In such examples, computing device 304 may be operatively coupled to display component 306 by a communication channel 346A, which may be a system bus or other suitable connection. Computing device 304 may also be operatively coupled to communication unit 322, further described below, by a communication channel 346B, which may also be a system bus or other suitable connection. Although shown separately as an example in FIG. 3, computing device 304 may be operatively coupled to display component 306 and communication unit 322 by any number of one or more communication channels.

In other examples, such as illustrated previously by computing device 104 in FIG. 1 and computing device 204 in FIG. 2, a computing device may refer to a portable or mobile device such as a mobile phone (including smart phone), laptop computer, smartwatch, etc. In some examples, a computing device may be a desktop computer, tablet computer, smart television platform, gaming console, remote controller, electronic camera, personal digital assistant (PDA), server, mainframe, etc.

Display component 306, like display component 106 as shown in FIG. 1, may include display component 340 and presence-sensitive input component 342. Display component 340 may, for example, receive data from computing device 304 and display the screen content. In some examples, presence-sensitive input component 342 may determine one or more user inputs (e.g., continuous gestures, multi-touch gestures, single-touch gestures, etc.) at display component 306 using capacitive, inductive, and/or optical recognition techniques and send indications of such user input to computing device 304 using communication channel 346A. In some examples, presence-sensitive input component 342 may be physically positioned on top of display component 340 such that, when a user positions an input unit over a graphical element displayed by display component 340, the location at which presence-sensitive input component 342 corresponds to the location of display component 340 at which the graphical element is displayed. In other examples, presence-sensitive input component 342 may be positioned physically apart from display component 340, and locations of presence-sensitive input component 342 may correspond to locations of display component 340, such that input can be made at presence-sensitive input component 342 for interacting with graphical elements displayed at corresponding locations of display component 340.

As shown in FIG. 3, computing device 304 may also include and/or be operatively coupled with communication unit 322. Communication unit 322 may include functionality of communication unit 222 as described in FIG. 2. Examples of communication unit 322 may include a network interface card, an Ethernet card, an optical transceiver, a radio frequency transceiver, or any other type of device that can send and receive information. Other examples of such communication units may include Bluetooth, 3G, and Wi-Fi radios, Universal Serial Bus (USB) interfaces, etc. Computing device 304 may also include and/or be operatively coupled with one or more other devices, e.g., input components, output components, memory, storage devices, etc. that are not shown in FIG. 3 for purposes of brevity and illustration.

FIG. 3 also illustrates a projector 356 and projector screen 358. Other such examples of projection devices may include electronic whiteboards, holographic display components, and any other suitable devices for displaying screen content. Projector 356 and projector screen 358 may include one or more communication units that enable the respective devices to communicate with computing device 304. In some examples, the one or more communication units may enable communication between projector 356 and projector screen 358. Projector 356 may receive data from computing device 304 that includes screen content. Projector 356, in response to receiving the data, may project the screen content onto projector screen 358. In some examples, projector 356 may determine one or more user inputs (e.g., continuous gestures, multi-touch gestures, single-touch gestures, etc.) at projector screen using optical recognition or other suitable techniques and send indications of such user input using one or more communication units to computing device 304. In such examples, projector screen 358 may be unnecessary, and projector 356 may project screen content on any suitable medium and detect one or more user inputs using optical recognition or other such suitable techniques.

Projector screen 358, in some examples, may include a presence-sensitive display 360. Presence-sensitive display 360 may include a subset of functionality or all of the functionality of display component 106 as described in this disclosure. In some examples, presence-sensitive display 360 may include additional functionality. Projector screen 358 (e.g., an electronic whiteboard), may receive data from computing device 304 and display the screen content. In some examples, presence-sensitive display 360 may determine one or more user inputs (e.g., continuous gestures, multi-touch gestures, single-touch gestures, etc.) at projector screen 358 using capacitive, inductive, and/or optical recognition techniques and send indications of such user input using one or more communication units to computing device 304.

FIG. 3 also illustrates mobile device 362 and visual display component 366. Mobile device 362 and visual display component 366 may each include computing and connectivity capabilities. Examples of mobile device 362 may include e-reader devices, convertible notebook devices, hybrid slate devices, etc. Examples of visual display component 366 may include other semi-stationary devices such as televisions, computer monitors, etc. As shown in FIG. 3, mobile device 362 may include a presence-sensitive display 364. Visual display component 366 may include a presence-sensitive display 368. Presence-sensitive displays 364, 368 may include a subset of functionality or all of the functionality of display component 306 as described in this disclosure. In some examples, presence-sensitive displays 364, 368 may include additional functionality. In any case, presence-sensitive display 364, for example, may receive data from computing device 304 and display the screen content. In some examples, presence-sensitive display 368 may determine one or more user inputs (e.g., continuous gestures, multi-touch gestures, single-touch gestures, etc.) at projector screen using capacitive, inductive, and/or optical recognition techniques and send indications of such user input using one or more communication units to computing device 304.

As described above, in some examples, computing device 304 may output screen content for display at display component 306 that is coupled to computing device 304 by a system bus or other suitable communication channel. Computing device 304 may also output screen content for display at one or more remote devices, such as projector 356, projector screen 358, mobile device 362, and visual display component 366. For instance, computing device 304 may execute one or more instructions to generate and/or modify screen content in accordance with techniques of the present disclosure. Computing device 304 may output the data that includes the screen content to a communication unit of computing device 304, such as communication unit 322. Communication unit 322 may send the data to one or more of the remote devices, such as projector 356, projector screen 358, mobile device 362, and/or visual display component 366. In this way, computing device 304 may output the screen content for display at one or more of the remote devices. In some examples, one or more of the remote devices may output the screen content at a display component that is included in and/or operatively coupled to the respective remote devices.

In some examples, computing device 304 may not output screen content at display component 306 that is operatively coupled to computing device 304. In other examples, computing device 304 may output screen content for display at both a display component 306 that is coupled to computing device 304 by communication channel 346A, and at one or more remote devices. In such examples, the screen content may be displayed substantially contemporaneously at each respective device. For instance, some delay may be introduced by the communication latency to send the data that includes the screen content to the remote device. In some examples, screen content generated by computing device 304 and output for display at display component 306 may be different than screen content display output for display at one or more remote devices.

Computing device 304 may send and receive data using any suitable communication techniques. For example, computing device 304 may be operatively coupled to external network 350 using network link 348A. Each of the remote devices illustrated in FIG. 3 may be operatively coupled to external network 350 by one of respective network links 348B, 348C, and 348D. External network 350 may include network hubs, network switches, network routers, etc., that are operatively inter-coupled thereby providing for the exchange of information between computing device 304 and the remote devices illustrated in FIG. 3. In some examples, network links 348A-348D may be Ethernet, ATM or other network connections. Such connections may be wireless and/or wired connections.

In some examples, computing device 304 may be operatively coupled to one or more of the remote devices included in FIG. 3 using direct device communication 354. Direct device communication 354 may include communications through which computing device 304 sends and receives data directly with a remote device, using wired or wireless communication. That is, in some examples of direct device communication 354, data sent by computing device 304 may not be forwarded by one or more additional devices before being received at the remote device, and vice-versa. Examples of direct device communication 354 may include Bluetooth, Near-Field Communication, Universal Serial Bus, WiFi, infrared, etc. One or more of the remote devices illustrated in FIG. 3 may be operatively coupled with computing device 304 by communication links 352A-352D. In some examples, communication links 352A-352D may be connections using Bluetooth, Near-Field Communication, Universal Serial Bus, infrared, etc. Such connections may be wireless and/or wired connections.

As discussed above, computing device 304 may output, for display at a display component (e.g., projector 356, mobile device 362, or visual display component 366) a graphical user interface of an application. The application may be included in a set of applications operating at the computing device. Responsive to determining that the graphical user interface of the application is output for display in a foreground of the display component, computing device 304 may determine context data from content included in the graphical user interface. Based at least in part on the context data, computing device 304 may determine an indication of assistance that is contextually related to the content included in the graphical user interface. Computing device 304 may output the indication of assistance.

FIG. 4 is a conceptual diagram illustrating an example system including a server device that provides an indication of assistance based on determined screen context of a remote display component, in accordance with one or more aspects of the present disclosure. The techniques of FIG. 4 may be performed by one or more processors of a computing device, such as computing device 104 and 204 illustrated in FIG. 1 and FIG. 2, respectively. For purposes of illustration, the techniques of FIG. 4 are described within the context of computing device 104 of FIG. 1, although computing devices having configurations different than that of computing device 104 may perform the techniques of FIG. 4.

In accordance with techniques of this disclosure, a display component (e.g., display component 106) of computing device 104 may output graphical user interface 470 of an application. In the example of FIG. 4, display component 106 of computing device 104 may output graphical user interface 470 that depicts a level of a video game, such as level 3 of the fictional “Jumping Man” game application 108B.

Context module 111 of computing device 104 may determine that graphical user interface 470 of the application is output for display in a foreground of display component 118. In doing so, context module 111 may access the view hierarchy managed by the application. Context module 111 may determine which application is associated with graphical user interface 470 currently output for display in display component 106. For instance, context module 111 may determine that the application is associated with or has otherwise generated graphical user interface 470 for the application. As stated above, context module 111 may operate with operating system privileges or be implemented in or have access to a runtime library of computing device 104 that allowed context module 111 to access the application list in order to determine that application associated with the graphical user interface in the foreground. Context module 111 may analyze the view hierarchy and view objects of the currently displayed screen to determine content and context data. In some examples, content may be any item output by a computing device, such as in a graphical user interface. Examples of view objects may include, but are not limited to, textual information, image information, frame information, linear information, pattern information, or button information, among other properties.

Responsive to determining that graphical user interface 470 of application 108B is output for display in the foreground of display component 106, context module 111 of computing device 104 may determine context data from content included in graphical user interface 470. In some examples, context data may be a determined general description of the content. Examples of context data may include, but are not limited to, a determination that the content is a restaurant name, a level of a video game, an address of a nearby place, a singer's name, or a calendar event, among other things.

In the example of FIG. 4, graphical user interface 470 includes only graphical images. As such, in determining the context data, context module 111 of computing device 104 may capture a screenshot of graphical user interface 470 of the application displayed in the foreground of the display component. Context module 111 may perform an image analysis on the screenshot. For example, context module 111 may perform an image search on the internet to determine what is being depicted in graphical user interface 470. In the example of FIG. 4, an image search on the internet may provide context module 111 with information that the contents of the image include level 3 of the fictional game “Jumping Man”. Based on this image analysis, context module 111 may determine the context data.

Assist module 110 may determine, based at least in part on the context data determined above, an indication of assistance that is contextually related to the content included in graphical user interface 470. An indication of assistance may be a possible action to be conducted based at least in part on the context data and the content. Examples of indication of assistance may include, but are not limited to, looking at reviews of an establishment, obtaining a reservation for an establishment, obtaining tickets to an event, summoning a taxi to take a user to an address, obtaining directions to an address, searching for music by an artist, adding an event to a calendar, obtaining assistance for a video game, or searching for information on a person, place, or thing, among other things.

In the example of FIG. 4, assist module 110 may be operating on remote server 474. As such, context module 111 may send the context data to remote server 474, which determines information for the indication of assistance. Remote server 474 may be a computing device operatively connected to the client's computing device via a network using a wired and/or wireless connection. For instance, remote server 474 may be a server computing device or a desktop computing device. Assist module 110 on remote server 474 may determine the indication of assistance, and context module 111 may receive the information for the indication of assistance from assist module 110.

In the example of FIG. 4, the primary context data may include the data level 3 of the game “Jumping Man”. Other secondary context data, if used, may include the amount of time the user has been in the application or the general difficulty of level 3 of the game “Jumping Man”. Based on this context data, assist module 110 may determine that the user would like to be taken to a strategy guide for how to beat level 3 of the game “Jumping Man”, or the user would like to be taken to a video walkthrough of this level.

Context module 111 may, utilizing display component 106 of computing device 104, output the indications of assistance 472. The indication of assistance may be in any suitable form for presentation, such as an overlay on the screen, an overlay near the content on the screen, a pop-up window within the graphical user interface, or an audio indication, among other things. In the example of FIG. 4, indication of assistance 472 is a pop-up window within graphical user interface 470. Interacting with indication of assistance 472 may launch a web browsing application that loads a website discussing how to beat level 3 of the game “Jumping Man”. In other examples, interacting with indication of assistance 472 may launch a video streaming application with a video tutorial for this particular stage.

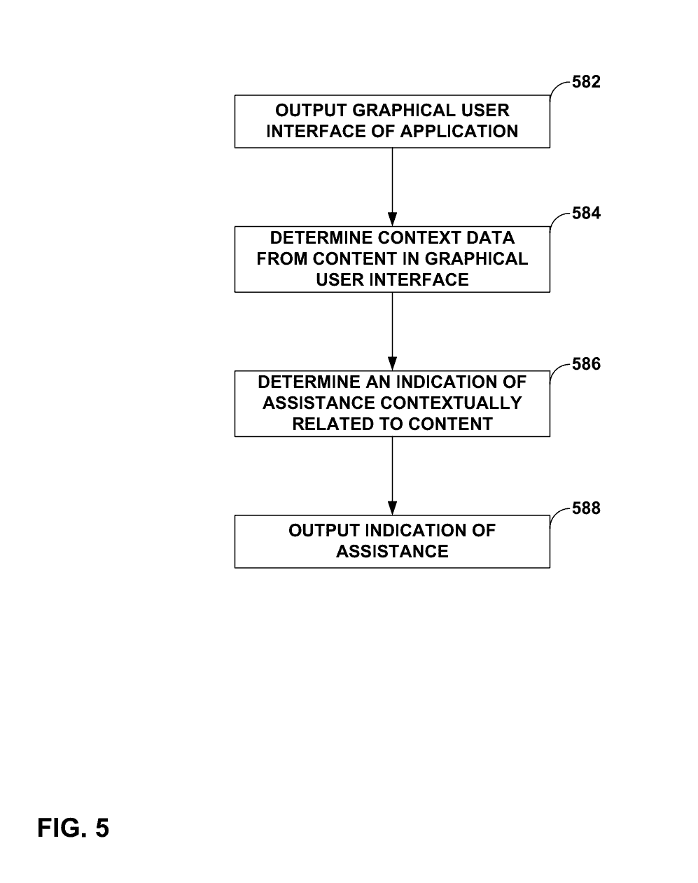

FIG. 5 is a flow chart illustrating example operations of a computing device that implements techniques for determining an indication of assistance, in accordance with one or more aspects of the present disclosure. The techniques of FIG. 5 may be performed by one or more processors of a computing device, such as computing device 104 and 204 illustrated in FIG. 1 and FIG. 2, respectively. For purposes of illustration, the techniques of FIG. 5 are described within the context of computing device 104 of FIG. 1, although computing devices having configurations different than that of computing device 104 may perform the techniques of FIG. 5.

In accordance with techniques of this disclosure, a display component (e.g., display component 106) of computing device 104 may output, for display at a display component (e.g., display component 118) that is operatively coupled to computing device 104, a graphical user interface (e.g., graphical user interface 112) of an application (e.g., application 118A) (582). Context module 111 may access the view hierarchy of running application 108 and identify a view object of the view hierarchy that is represented in the graphical user interface. Context module 111 may determine which application is associated with graphical user interface 112 currently output for display in the foreground of display component 106. For instance, context module 111 may determine that application 108A is associated with or has otherwise generated graphical user interface 112 for application 108A. In some examples, graphical user interface 112 currently output for display on display component 106 may be associated with the most recently viewed or accessed application. As stated above, context module 111 may operate with operating system privileges or be implemented in or have access to a runtime library of computing device 104 that allowed context module 111 to access the application list in order to determine the application associated with the graphical user interface and the view hierarchy for said application. Context module 111 may access the content of the currently displayed view. In some examples, content may be any item output by a computing device, such as in a graphical user interface. Examples of view objects may include, but are not limited to, textual information, image information, frame information, linear information, pattern information, or button information, among other properties. Context module 111 may further extract at least one property of the view object and determine, based at least in part on the at least one property, the context data.

Responsive to determining that graphical user interface 112 of application 108A is output for display in the foreground of display component 106, context module 111 of computing device 104 may determine context data from content (e.g., content 114A-114C) included in graphical user interface 112 (584). The content of the graphical user interface 112 may include not only visible content of a type that a screen shot can capture but also additional content available from view objects and a view hierarchy. In some examples, context data may be a determined general description of the content determined either through (i) an analysis of text, icons, images, and video displayed by the display component 106; and/or (b) an analysis of properties of view objects that support the visible text, icons, images, and video. Examples of context data may include, but are not limited to, a determination that the content is a restaurant name, a level of a video game, an address of a nearby place, a singer's name, or a calendar event, among other things.

Assist module 110 of computing device 104 may determine, based at least in part on the context data determined above, an indication of assistance that is contextually related to content 114A-114C included in graphical user interface 112 (586). An indication of assistance may be a possible action to be conducted based at least in part on the context data and the content. Examples of indication of assistance may include, but are not limited to, looking at reviews of an establishment, obtaining a reservation for an establishment, obtaining tickets to an event, summoning a taxi to take a user to an address, obtaining directions to an address, searching for music by an artist, adding an event to a calendar, obtaining assistance for a video game, or searching for information on a person, place, or thing, among other things.

Assist module 110 may, utilizing display component 106 of computing device 104, output the indications of assistance (588). The indication of assistance may be in any suitable form for presentation, such as an overlay on the screen, an overlay near the content on the screen, a pop-up window within the graphical user interface, or an audio indication, among other things.

While the techniques of FIG. 1 have been described with respect to one or more operations on computing device 104, one or more operations of assist module 110 may be performed on a remote server. Context module 111 may send the contextual data to the remote server that determines possible indications of assistance, which are then sent to assist module 110, which is responsible for formatting the results and outputting the results to the screen in a particular form (such as an overlay).

By determining the context based on content of the graphical user interface displayed in the foreground of the display component, a computing device can make recommendations about likely next actions for a user without relying on application developers to explicitly include contextual information in the code of the application itself. In this manner, techniques of the disclosure may provide mobile devices with the capability to determine likely next actions and provide indications of assistance for any application that the computing device may run without requiring application developers to include any additional code, simplifying the code of applications running on the computing device. By extracting text and/or images from the screen being displayed by the application, techniques of this disclosure provide the content to an assist module that uses the context to provide indications of assistance regarding potential next actions based on what the user was doing in any possible application rather than what the application developer explicitly provided via hard coding the contextual information. In providing functionality to the computing device to determine content and provide context, application coding is simplified and assistance can be provided universally across primary developer applications and third party applications in a reliable way. Further, techniques of this disclosure may allow assistance to be more generalizable to screen content that is output for display.

### Example 1

A method comprising: outputting, by a computing device and for display at a display component that is operatively coupled to the computing device, a graphical user interface of an application; determining context data from content included in the graphical user interface; determining, based at least in part on the context data, an indication of assistance that is contextually related to the content included in the graphical user interface; and outputting, by the computing device, the indication of the assistance.

### Example 2

The method of example 1, wherein determining the context data comprises: accessing a view hierarchy at the computing device; and identifying a view object of the view hierarchy that is represented in the graphical user interface.

### Example 3

The method of example 2, further comprising: extracting at least one property of the view object; and determining, based at least in part on the at least one property, at least a portion of the context data.

### Example 4

The method of any of examples 1-3, wherein the context data from content included in the graphical user interface is primary context data, and wherein determining the indication of assistance comprises: determining the indication of assistance based at least in part on the primary context data of the graphical user interface and secondary context data, wherein the secondary context data comprises at least one of a location, a time, a user identity, cloud computing data, calendar information, contact information, a previous application, and a temporal relation between a current time and a time that the previous application was run.

### Example 5

The method of any of examples 1-4, wherein determining the context data comprises: capturing a screenshot of the graphical user interface of the application; performing an image analysis on the screenshot; and determining, based at least in part on the image analysis, the context data.

### Example 6

The method of example 5, wherein performing the image analysis comprises: performing an optical character recognition process on the screenshot to determine one or more characters in the screenshot; and determining, based at least in part on the one or more characters, the context data.

### Example 7

The method of any of examples 1-6, wherein determining the context data comprises: analyzing a view hierarchy of the application; for a view object included in the view hierarchy: identifying the view object; determining information associated with the identified view object; and determining, based at least in part on the determined information, at least a portion of the context data

### Example 8

The method of any of examples 1-7, wherein determining the indication of assistance further comprises: sending, to a remote computing device, the context data, wherein the remote computing device determines information for the indication of assistance from the context data; receiving, from the remote computing device, the information for the indication of assistance; and generating for annunciation, based at least in part on the information, the indication of assistance.

### Example 9

A computing device comprising: at least one processor; and at least one module, operable by the at least one processor to: output, for display at a display component that is operatively coupled to the computing device, a graphical user interface of an application; determine context data from content included in the graphical user interface; determine, based at least in part on the context data, an indication of assistance that is contextually related to the content included in the graphical user interface; and output the indication of the assistance.

### Example 10

The computing device of example 9, wherein the at least one module is executing with operating system privileges on the computing device, and wherein the at least one module is operable by the at least one processor to: extract at least one property of the view object; and determine, based at least in part on the at least one property, at least a portion of the context data.

### Example 11

The computing device of any of examples 9-10, wherein the at least one module operable by the at least one processor is further operable to: send, to a remote computing device, the context data, wherein the remote computing device determines information for the indication of assistance from the context data; receive, from the remote computing device, the information for the indication of assistance; and generate for annunciation, based at least in part on the information, the indication of assistance.

### Example 12

The computing device of any of examples 9-11, wherein the context data from content included in the graphical user interface is primary context data, and wherein the at least one module is further operable to: determine the indication of assistance based at least in part on the primary context data of the graphical user interface and secondary context data, wherein the secondary context data comprises at least one of a location, a time, a user identity, cloud computing data, calendar information, contact information, a previous application, and a temporal relation between a current time and a time that the previous application was run.

### Example 13

The computing device of any of examples 9-12, wherein the at least one module is operable by the at least one processor to: capture a screenshot of the graphical user interface; perform an image analysis on the screenshot; and determine, based at least in part on the image analysis, the context data.

### Example 14

The computing device of example 13, wherein the at least one module is operable by the at least one processor to: perform an optical character recognition process on the screenshot to determine one or more characters in the screenshot; and determine, based at least in part on the one or more characters, the context data.

### Example 15

The computing device of any of examples 9-14, wherein the at least one module is operable by the at least one processor to determine context data from content included in the graphical user interface to: analyze a view hierarchy of the application at the computing device; identify a view object included in the view hierarchy that is represented in a current screen image of the graphical user interface of the application; for the view object included in the view hierarchy: determine information associated with the view object; and determine, based at least in part on the determined information, the context data.

### Example 16

A computer-readable storage medium encoded with instructions that, when executed, cause at least one processor of a computing device to: output, for display at a display component that is operatively coupled to the computing device, a graphical user interface of an application; determine context data from content included in the graphical user interface; determine, based at least in part on the context data, an indication of assistance that is contextually related to the content included in the graphical user interface; and output the indication of the assistance.

### Example 17

The computer-readable storage medium of example 16, wherein the instructions causing the at least one processor to determine the indication of assistance comprise instructions that, when executed, cause the at least one processor of the computing device to: send, to a remote computing device, the context data, wherein the remote computing device determines information for the indication of assistance; receive, from the remote computing device, the information for the indication of assistance; and generate for annunciation, based at least in part on the information, the indication of assistance from the context data.

### Example 18

The computer-readable storage medium of any of examples 16-17, wherein the instructions causing the at least one processor to determine the context data comprise instructions that, when executed, cause the at least one processor of the computing device to: access a view hierarchy at the computing device; identify a view object of the view hierarchy that is represented in the graphical user interface; extract at least one property of the view object; and determine, based at least in part on the at least one property, at least a portion of the context data.

### Example 19

The computer-readable storage medium of any of examples 17 or 18, wherein the context data from content included in the graphical user interface is primary context data, and wherein the instructions causing the at least one processor to determine the indication of assistance comprise instructions that, when executed, cause the at least one processor of the computing device to determine the indication of assistance based at least in part on the primary context data and a set of secondary context data, wherein the set of secondary context data comprises at least one of a location, a time, a user identity, cloud computing data, calendar information, contact information, a previous application, and a temporal relation between a current time and a time that the previous application was run.

### Example 20

The computer-readable storage medium of any of examples 17-19, wherein the instructions causing the at least one processor to determine the context data comprise instructions that, when executed, cause the at least one processor of the computing device to: capture a screenshot of the graphical user interface; perform an image analysis on the screenshot; and determine, based at least in part on the image analysis, the context data.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

### Example 21

A device comprising means for performing the method of any combination of examples 1-8.

### Example 22

A computer-readable storage medium encoded with instructions that, when executed, cause at least one processor of a computing device to perform the method of any combination of examples 1-8.

Throughout the disclosure, examples are described where a computing device and/or a computing system may analyze information (e.g., locations, speeds, etc.) associated with a computing device only if the computing device receives permission from the user to analyze the information. For example, in situations discussed below in which the computing device may collect or may make use of information associated with the user, the user may be provided with an opportunity to provide input to control whether programs or features of the computing device can collect and make use of user information (e.g., information about a user's current location, current speed, etc.), or to dictate whether and/or how to the computing device may receive content that may be relevant to the user. In addition, certain data may be treated in one or more ways before it is stored or used by the computing device and/or computing system, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by the computing device.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the embodiment, certain acts or events of any of the methods described herein can be performed in a different sequence, may be added, merged, or left out altogether (e.g., not all described acts or events are necessary for the practice of the method). Moreover, in certain embodiments, acts or events may be performed concurrently, e.g., through multi-threaded processing, interrupt processing, or multiple processors, rather than sequentially.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the disclosure have been described. Any combination of the described systems, operations, or functions is contemplated. These and other examples are within the scope of the following claims.

1. A method comprising:
outputting, by a computing device and for display at a display component that is operatively coupled to the computing device, a graphical user interface of an application;
determining context data from content included in the graphical user interface that is output for display;
determining, based at least in part on the context data, an indication of assistance that is contextually related to the content included in the graphical user interface; and
outputting, by the computing device, the indication of the assistance.

2. The method of claim 1, wherein determining the context data comprises:
accessing a view hierarchy at the computing device; and
identifying a view object of the view hierarchy that is represented in the graphical user interface.

3. The method of claim 2, further comprising:
extracting at least one property of the view object; and
determining, based at least in part on the at least one property, at least a portion of the context data.

4. The method of claim 1, wherein the context data from content included in the graphical user interface is primary context data, and wherein determining the indication of assistance comprises:
determining the indication of assistance based at least in part on the primary context data of the graphical user interface and secondary context data, wherein the secondary context data comprises at least one of a location, a time, a user identity, cloud computing data, calendar information, contact information, a previous application, and a temporal relation between a current time and a time that the previous application was run.

5. The method of claim 1, wherein determining the context data comprises:
capturing a screenshot of the graphical user interface of the application;
performing an image analysis on the screenshot; and
determining, based at least in part on the image analysis, the context data.

6. The method of claim 5, wherein performing the image analysis comprises:
performing an optical character recognition process on the screenshot to determine one or more characters in the screenshot; and
determining, based at least in part on the one or more characters, the context data.

7. The method of claim 1, wherein determining the context data comprises:
analyzing a view hierarchy of the application;
for a view object included in the view hierarchy:
identifying the view object;
determining information associated with the identified view object; and
determining, based at least in part on the determined information, at least a portion of the context data.

8. The method of claim 1, wherein determining the indication of assistance further comprises:
sending, to a remote computing device, the context data, wherein the remote computing device determines information for the indication of assistance from the context data;
receiving, from the remote computing device, the information for the indication of assistance; and
generating for annunciation, based at least in part on the information, the indication of assistance.

9. A computing device comprising:
at least one processor; and
at least one module, operable by the at least one processor to:
output, for display at a display component that is operatively coupled to the computing device, a graphical user interface of an application;
determine context data from content included in the graphical user interface;
determine, based at least in part on the context data, an indication of assistance that is contextually related to the content included in the graphical user interface; and
output the indication of the assistance.

10. The computing device of claim 9, wherein the at least one module is executing with operating system privileges on the computing device, and wherein the at least one module is operable by the at least one processor to:
extract at least one property of the view object; and
determine, based at least in part on the at least one property, at least a portion of the context data.

11. The computing device of claim 9, wherein the at least one module operable by the at least one processor is further operable to:
send, to a remote computing device, the context data, wherein the remote computing device determines information for the indication of assistance from the context data;
receive, from the remote computing device, the information for the indication of assistance; and
generate for annunciation, based at least in part on the information, the indication of assistance.

12. The computing device of claim 9, wherein the context data from content included in the graphical user interface is primary context data, and wherein the at least one module is further operable to:
determine the indication of assistance based at least in part on the primary context data of the graphical user interface and secondary context data, wherein the secondary context data comprises at least one of a location, a time, a user identity, cloud computing data, calendar information, contact information, a previous application, and a temporal relation between a current time and a time that the previous application was run.

13. The computing device of claim 9, wherein the at least one module is operable by the at least one processor to:
capture a screenshot of the graphical user interface;
perform an image analysis on the screenshot; and
determine, based at least in part on the image analysis, the context data.

14. The computing device of claim 13, wherein the at least one module is operable by the at least one processor to:
perform an optical character recognition process on the screenshot to determine one or more characters in the screenshot; and
determine, based at least in part on the one or more characters, the context data.

15. The computing device of claim 9, wherein the at least one module is operable by the at least one processor to determine context data from content included in the graphical user interface to:
analyze a view hierarchy of the application at the computing device;
identify a view object included in the view hierarchy that is represented in a current screen image of the graphical user interface of the application;
for the view object included in the view hierarchy:
determine information associated with the view object; and
determine, based at least in part on the determined information, the context data.

16. A computer-readable storage medium encoded with instructions that, when executed, cause at least one processor of a computing device to:
output, for display at a display component that is operatively coupled to the computing device, a graphical user interface of an application;
determine context data from content included in the graphical user interface;
determine, based at least in part on the context data, an indication of assistance that is contextually related to the content included in the graphical user interface; and
output the indication of the assistance.

17. The computer-readable storage medium of claim 16, wherein the instructions causing the at least one processor to determine the indication of assistance comprise instructions that, when executed, cause the at least one processor of the computing device to:
send, to a remote computing device, the context data, wherein the remote computing device determines information for the indication of assistance from the context data;
receive, from the remote computing device, the information for the indication of assistance; and
generate for annunciation, based at least in part on the information, the indication of assistance.

18. The computer-readable storage medium of claim 16, wherein the instructions causing the at least one processor to determine the context data comprise instructions that, when executed, cause the at least one processor of the computing device to:
access a view hierarchy at the computing device;
identify a view object of the view hierarchy that is represented in the graphical user interface;
extract at least one property of the view object; and
determine, based at least in part on the at least one property, at least a portion of the context data.

19. The computer-readable storage medium of claim 16, wherein the context data from content included in the graphical user interface is primary context data, and wherein the instructions causing the at least one processor to determine the indication of assistance comprise instructions that, when executed, cause the at least one processor of the computing device to determine the indication of assistance based at least in part on the primary context data and a set of secondary context data, wherein the set of secondary context data comprises at least one of a location, a time, a user identity, cloud computing data, calendar information, contact information, a previous application, and a temporal relation between a current time and a time that the previous application was run.

20. The computer-readable storage medium of claim 16, wherein the instructions causing the at least one processor to determine the context data comprise instructions that, when executed, cause the at least one processor of the computing device to:
capture a screenshot of the graphical user interface;
perform an image analysis on the screenshot; and
determine, based at least in part on the image analysis, the context data.
